(19) United States
(12) Patent Application Publication
(10) Pub. No.: US 2011/0293033 A1
(43) Pub. Date: Dec. 1, 2011

(54) DEVICE, SYSTEM AND METHOD OF TRANSMITTER OUTPUT POWER MANAGEMENT

(76) Inventors: Igal Kushnir, Azor (IL); Ofir Degani, Haifa (IL)

(21) Appl. No.: 12/790,831

(22) Filed: May 30, 2010

(51) Int. Cl. H04B 1/04

(52) U.S. Cl. 375/295; 455/115.1

(57) ABSTRACT

Some demonstrative embodiments include devices, systems and/or methods of transmitter output power management. For example, a device may include a transmitter capable of generating a wireless communication signal, and maintaining at least one of a peak-to-average-power-ratio (PAPR) of the wireless communication signal and a transmission power of the transmitter substantially unaffected by at least one of a temperature of the transmitter and a supply voltage of the transmitter. Other embodiments are described and claimed.

### BACKGROUND

The output power of a wireless transmitter may vary, for example, in response to variations in supply voltage, temperature, manufacturing process and the like.

Elaborate and/or expensive production-line calibrations may be required in order to accurately estimate the output power of the transmitter.

Relatively large design and/or safety margins may be taken into account, for example, in order to ensure compliance with error-vector-magnitude (EVM) requirements, spectral mask requirements, and/or any other suitable requirements, e.g., of a standard, specification and/or protocol.

Such margins may result in increased power consumption of the transmitter, e.g., by as much as one hundred percent, compared to a transmitter not implementing the design margins.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a graph depicting a plurality of spectral response curves corresponding to a respective plurality of saturation power levels of a power amplifier, in accordance with some demonstrative embodiments.

FIG. 3 is a schematic illustration of a transmitter, in accordance with one demonstrative embodiment.

FIG. 4 is a schematic illustration of a transmitter, in accordance with another demonstrative embodiment.

FIG. 5 is a schematic illustration of a graph depicting values of a saturation power of a transmitter versus values of a temperature of the transmitter, in accordance with some demonstrative embodiments.

FIGS. 6A, 6C and 6E schematically illustrate three different respective values of the average transmission power P_{TX} of a transmitter with respect to an amplitude to amplitude (AM2AM) curve; and FIGS. 6B, 6D and 6F schematically illustrate three curves representing momentarily output power values versus time corresponding to the three values of the average transmission power P_{TX}, respectively, in accordance with some demonstrative embodiments.

FIG. 7 is a schematic flow-chart illustration of a method of transmitter output power management, in accordance with some demonstrative embodiments.

FIG. 8 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a wired or wireless network, a wireless area network, a Wireless Video Area Network (WVAN), a Local Area Network (LAN), a Wireless LAN (WLAN), a Wireless Metropolitan Area Network (WMAN) communication system, a Personal Area Network (PAN), a Wireless PAN (WPAN), devices and/or networks operating in accordance with existing IEEE 802.11 (IEEE 802.11-1999: Wireless LAN Medium Access Control (MAC) and Physical Layer (PHY) Specifications), 802.11a, 802.11b, 802.11g, 802. 11h, 802.11j, 802.11n, 802.11 task group ad (TGad) (“the 802.16 standards”), 802.15.3c, 802.16 (IEEE-Std 802.16, 2004 Edition, Air Interface for Fixed Broadband Wireless Access Systems), 802.16d, 802.16e (IEEE-Std 802.16e, 2005 Edition, Physical and Medium Access Control Layers for Combined Fixed and Mobile Operation in Licensed Bands), 802.16f, 802.16m standards (“the 802.16 standards”) and/or future versions and/or derivatives thereof, devices and/or networks operating in accordance with existing Wireless-Gigabit-Alliance (WGA) and/or WirelessHD™ specifications and/or future versions and/or derivatives thereof, devices and/or networks operating in accordance with existing cellular specifications and/or protocols, e.g., 3rd Generation Partnership Project (3 GPP), 3 GPP Long Term Evolution (LTE), and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2 G, 2.5 G, 3 G, 3.5 G, Enhanced Data rates for GSM Evolution (EDGE), or the like. Other embodiments may be used in various other devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

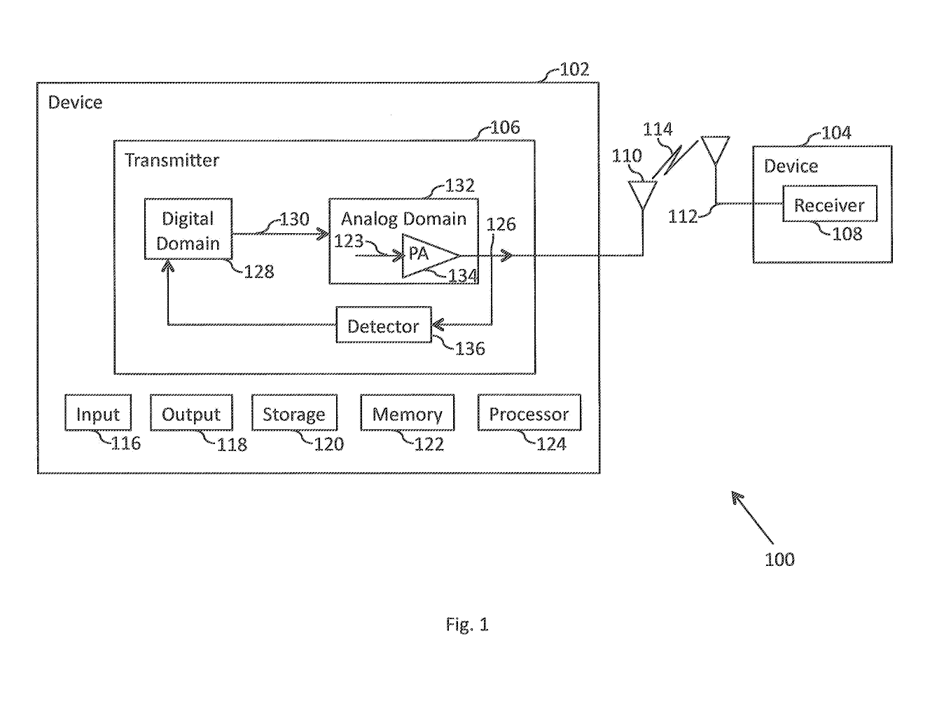

Reference is now made to FIG. 1, which schematically illustrates a block diagram of a system 100 in accordance with some demonstrative embodiments.

As shown in FIG. 1, in some demonstrative embodiments, system 100 may include one or more wireless communication devices, e.g., wireless communication devices 102 and/or 104, capable of communicating content, data, information and/or signals over at least one suitable wireless communication channel 114, for example, a radio channel, an IR channel, a RF channel, a Wireless Fidelity (WiFi) channel, and the like. One or more elements of system 100 may optionally be capable of communicating over any suitable wired communication links.

In some demonstrative embodiments, wireless communication devices 102 and/or 104 may include, for example, a PC, a desktop computer, a mobile computer, a laptop computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a cellular telephone, a handset, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, an AP, a base station, or the like.

In some demonstrative embodiments, device 102 may include a transmitter 105 to transmit a wireless transmission to device 104 via at least one antenna 110. Device 104 may include a receiver 108 to receive the wireless transmission from device 102, e.g., via at least one antenna 112. Types of antennas that may be used for antennas 110 and/or 112 may include but are not limited to internal antenna, dipole antenna, omni-directional antenna, a monopole antenna, an end fed antenna, a circularly polarized antenna, a micro-strip antenna, a diversity antenna and the like.

In some demonstrative embodiments, wireless communication devices 102 and/or 104 may also include, for example, one or more of a processor 124, an input unit 116, an output unit 118, a memory unit 122, and a storage unit 120. Wireless communication devices 102 and/or 104 may optionally include other suitable hardware components and/or software components. In some demonstrative embodiments, some or all of the components of each of wireless communication devices 102 and/or 110 may be enclosed in a common housing or packaging, and may be interconnected or operably associated using one or more wired or wireless links In other embodiments, components of each of wireless communication devices 102 and/or 104 may be distributed among multiple or separate devices.

Processor 124 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 124 executes instructions, for example, of an Operating System (OS) of wireless communication devices 102 and/or 104 and/or of one or more suitable applications.

Input unit 116 includes, for example, a keyboard, a keypad, a mouse, a touch-pad, a track-ball, a stylus, a microphone, or other suitable pointing device or input device. Output unit 118 includes, for example, a monitor, a screen, a flat panel display, a Cathode Ray Tube (CRT) display unit, a Liquid Crystal Display (LCD) display unit, a plasma display unit, one or more audio speakers or earphones, or other suitable output devices.

Memory unit 122 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 120 includes, for example, a hard disk drive, a floppy disk drive, a Compact Disk (CD) drive, a CD-ROM drive, a DVD drive, or other suitable removable or non-removable storage units. Memory unit 122 and/or storage unit 120, for example, may store data processed by wireless communication device 102 and/or 110.

In some demonstrative embodiments, transmitter 106 may generate a wireless communication signal 126 to be transmitted via antenna 110.

In some demonstrative embodiments, transmitter 106 may utilize a suitable non-constant envelope modulation to generate signal 126. For example, transmitter 106 may utilize a suitable OFDM scheme to generate signal 126 in the form of an OFDM wireless communication signal, a Single-Carrier Frequency Division Multiple Access (SC-FDMA), or any other modulation scheme to generate any other suitable signal.

In some demonstrative embodiments, wireless communication signal 126 may include an analog signal. For example, transmitter 106 may include any suitable digital domain 128 to generate a digital signal 130, and any suitable analog domain 132 to generate wireless communication signal 126 based on digital signal 130.

In some demonstrative embodiments, analog domain 132 may include at least one suitable power amplifier (PA) 134 to generate wireless communication signal 126, for example, by amplifying a power of at least one analog signal 123 generated within analog domain 132, e.g., as described below.

In some demonstrative embodiments, a peak-to-average-power-ratio (PAPR), an error vector magnitude (EVM) and/or a spectrum of wireless communication signal 126 may be directly dependent on each other. Accordingly, a mask compliance of transmitter 106 may be related to the PAPR of signal 126. Therefore, in some demonstrative embodiments, transmitter 106 may be capable of satisfying the mask compliance of transmitter 106, for example, by monitoring, controlling, adjusting and/or maintaining the PAPR of signal 126 and/or a value based on the PAPR of signal 126, e.g., as described in detail below.

In some demonstrative embodiments, a spectrum of signal 126 and/or the EVM of signal 126 may not be substantially affected by PA 134, for example, if PA 134 is a perfect linear amplifier or an “ideal clipping” amplifier, e.g., if no clip distortion is applied by PA 134 to signal 126.

In some demonstrative embodiments, it may be assumed that PA 134 may be capable of amplifying signal 123 according to a substantially linear amplitude-to-amplitude (“AM-AM” or “AM2AM”) amplification, e.g., without substantially any amplitude to for example, up to a “clipping point”, at which the power of input signal 123 is equal to or greater than a saturation power, denoted Pₛₐₜ, of power amplifier 134. For example, PA 134 may include an “ideal clipping” PA, or may utilize a suitable pre-distortion mechanism to correct a non-linearity of PA 134, e.g., to effectively provide the “ideal” clipping.

In some demonstrative embodiments, as the average power of signal 123 increases, PA 134 may cause a more profound clip to signal 123 and, as a result, the PAPR of the amplified output signal 126 may decrease. This decrease of the PAPR of signal 126 may result in the generation of higher inter-modulation distortion, for example, in the form of spectral re-growth, e.g., higher spectrum “wings”, and/or a lower EVM.

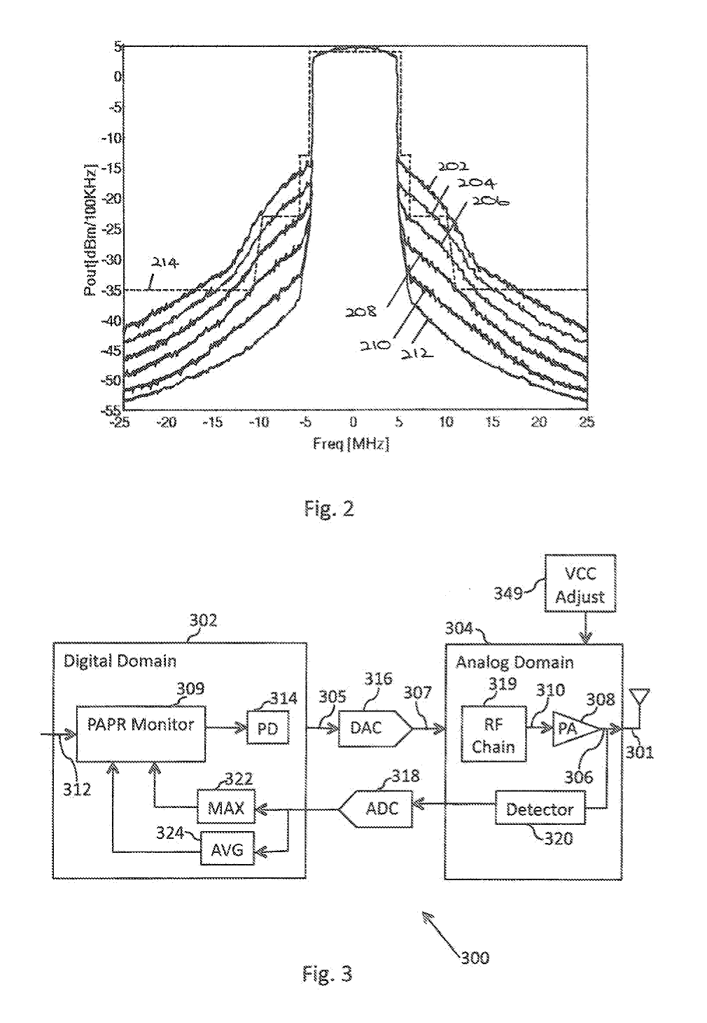

Reference is also made to FIG. 2, which schematically illustrates a graph depicting a plurality of spectral response curves corresponding to a respective plurality of saturation power levels of a PA, in accordance with some demonstrative embodiments. The spectral response curves depicted by FIG. 2 are based on simulations performed using arbitrary OFDM packets and an “ideal clipping” PA with different saturation power levels. Similar results may be achieved with respect to any other suitable type of transmission signals, e.g., SC-FDMA signals, and the like.

As shown in FIG. 2, a first spectral response curve 202 corresponds to a clipping level of Pₛₐₜ=27 dBm; a second spectral response curve 204 corresponds to a clipping level of Pₛₐₜ=28 dBm; a third spectral response curve 206 corresponds to a clipping level of Pₛₐₜ=29 dBm; a fourth spectral response curve 208 corresponds to a clipping level of Pₛₐₜ=30 dBm; a fifth spectral response curve 210 corresponds to a clipping level of Pₛₐₜ=31 dBm; and a sixth spectral response curve 212 corresponds to a clipping level of Pₛₐₜ=32 dBm. FIG. 2. also includes a 10 megahertz (MHz) mask 214 defined at an output transmission power of Pout=24 decibel-to-milliwatt (dBm), e.g., in accordance with the Federal Communications Commission (FCC) regulations and/or 802.16 standards. Other spectral responses, saturation power values and/or masks may be achieved and/or defined with respect to any other suitable wireless communication signals and/or standards, e.g., the 802.11 standards, the 3 GPP LTE standards, and the like. For example, the 802.11 standards may require a PAPR of 8 dB, e.g., to comply with FCC regulations with respect to some frequency channels.

As shown in FIG. 2, curve 208, which corresponds to the clipping level of Pₛₐₜ=30 dBm, is the curve having the lowest clipping level while still complying with the spectral mask 214. Accordingly, a 6 dB “back-off”, corresponding to the difference between the saturation power Pₛₐₜ=30 dBm and the power Pout=24 dBm, may be required in order, for example, for the “ideal clipping” PA to comply with the spectral mask 214. Therefore, an output PAPR of 6 dB may be sufficient, for example, for the “ideal clipping” PA to comply with the spectral mask 214.

Referring back to FIG. 1, in some demonstrative embodiments transmitter 106 may maximize the power level of signal 126, for example, without violation of a predefined transmission mask and/or a predefined quality factor, e.g., EVM and/or MSE, e.g., as described below.

In some demonstrative embodiments, transmitter 106 may monitor the output power of transmitter 106, e.g., to avoid violation of regulations that state maximum or minimum allowed transmission levels. For example, transmitter 106 may monitor the output power of transmitter 106 based on the saturated power and the PAPR, to allow reduction of margins kept to compensate for production variances temperature variations and/or supply voltage variations.

In some demonstrative embodiments, EVM and/or mask compliance requirements of transmitter 106 may be satisfied, for example, by maintaining the PAPR of signal 126 at a predefined level.

In some demonstrative embodiments, transmitter 106 may monitor the PAPR of wireless communication signal 126 and adjust the PAPR of wireless communication signal 126 based on a reference PAPR, e.g., as described in detail below.

In some demonstrative embodiments, transmitter 106 may maintain the PAPR of wireless communication signal 126 substantially independent of at least one of a temperature of transmitter 106 and a supply voltage (VCC) of transmitter 106 and/or PA 134, for example, by adjusting the PAPR of wireless communication signal 126, such that the PAPR of wireless communication signal 126 is substantially unaffected by variations in at least one of the temperature of transmitter 106 and the supply voltage of transmitter 106 and/or PA 134. For example, in some demonstrative embodiments transmitter 106 may maintain the PAPR of wireless communication signal 126 substantially independent of both the temperature and the supply voltage of transmitter 106, e.g., as described below with reference to FIG. 3.

The phrase “substantially independent” as used herein, with reference to maintaining a first parameter substantially independent of a second parameter, may refer to maintaining a value of the first parameter substantially unaffected by variations in the second parameter and/or unchanged or with a change, which is within a predefined variation range, in response to a change, e.g., any change, in a value of the second parameter. For example, maintaining the PAPR of signal 126 substantially independent of the temperature and/or supply voltage of transmitter 106 may include maintaining the PAPR of signal 126 unchanged, or with a change within a predefined variation range, for example, a change of no more than five percent, e.g., a change of no more than one percent, in response to a change, e.g., any change, in the temperature and/or the supply voltage VCC.

In some demonstrative embodiments, transmitter 106 may monitor, adjust and/or maintain the PAPR of wireless communication signal 116 based on a PAPR of digital signal 130, e.g., as described in detail below with reference to FIG. 3.

In some demonstrative embodiments, transmitter 106 may include a detector 136 to detect power-related values of wireless communication signal 126; and transmitter 106 may determine the PAPR of wireless communication signal 126 based on the power-related values detected by detector 136. Detector 136 may include any suitable detector, for example, a suitable envelope or scalar detector, a suitable vector or loop-back detector, e.g., an IQ detector, and the like. For example, transmitter 106 may determine the PAPR of signal 126 by determining a maximal power value of a detected power envelope of signal 126, determining an average power value of the detected power envelope, and determining a ratio between the maximal power value and the average power value, e.g., as described below with reference to FIGS. 3 and/or 4.

Reference is now made to FIG. 3, which schematically illustrates a transmitter 300, in accordance with one demonstrative embodiment. Transmitter 300 may perform, for example, the functionality of transmitter 106 (FIG. 1).

In some demonstrative embodiments, transmitter 300 may include a digital domain 302 to process a digital wireless communication signal 312; at least one digital-to-analog-converter (DAC) 316 to convert at least one digital output 305 of digital domain 302 into at least one analog input 307 to be provided to an analog domain 304. Analog domain 304 may include a suitable transmitter chain 319, to generate an analog wireless communication signal 310 based on analog input 307; and at least one power amplifier 308 to amplify analog wireless communication signal 310 to provide an amplified wireless communications signal 306 to be transmitted via at least one antenna 301.

In some demonstrative embodiments, transmitter 300 may monitor, adjust and/or maintain the PAPR of wireless communication signal 306, for example, such that the PAPR of wireless communication signal 306 is substantially unaffected by variations in at least one of a temperature of transmitter 300 and a supply voltage of transmitter 300. For example, transmitter 300 may maintain the PAPR of signal 306 unchanged, or with a change within a predefined variation range, for example, a change of no more than five percent, e.g., a change of no more than one percent, in response to a change, e.g., any change, in the temperature and/or supply voltage of transmitter 300.

In some demonstrative embodiments, transmitter 300 may monitor, adjust and/or maintain the PAPR of wireless communication signal 306 based on a reference PAPR, for example, a PAPR of digital signal 312, e.g., as described in detail below.

In some demonstrative embodiments, digital domain 302 may include a PAPR monitor 309 capable of monitoring the PAPR of wireless communication signal 306 and the PAPR of digital signal 312, e.g., as described in detail below.

In some demonstrative embodiments, PAPR monitor 309 may determine the PAPR of digital signal 312. Digital domain 302 may apply to signal 312 any suitable processing, e.g., gain, clipping, shaping, filtering and the like, to achieve a suitable PAPR, e.g., a minimal PAPR complying with a required EVM and/or spectral mask. For example, digital domain 302 may process signal 312 to achieve a PAPR of 6 dB, for example, in accordance with the 802.16 standards, e.g., as described above with reference to FIG. 2, or any other suitable PAPR in accordance with any other suitable standards and/or requirements. Digital domain 302 and/or analog domain 304 may also include any suitable pre-distortion module 314, for example, in order to ensure that PA 308 acts as a substantially “ideal clipping” PA.

In some demonstrative embodiments, the EVM and/or spectrum of signal 306 may be similar to the respective EVM and spectrum of digital signal 312, for example, as long as signal 306 is undistorted by one or more elements of analog domain 304. Accordingly, the EVM and/or spectral compliance of signal 306 may be guaranteed by ensuring the EVM and/or spectral compliance of signal 302, for example, as long as signal 306 is undistorted by one or more elements of analog domain 304. The EVM and/or spectral compliance of signal 306 may not be guaranteed by ensuring spectral compliance of signal 312, for example, if signal 306 is distorted by analog domain 304.

In some demonstrative embodiments, transmitter 300 may be capable of determining the PAPR of signal 306. For example, transmitter 300 may include a suitable PAPR detection mechanism. In one example, transmitter 300 may include a suitable envelope detector 320, which may be implemented as part of analog domain 304, to detect a power envelope of signal 306. Transmitter 300 may also include a suitable analog-to-digital converter (ADC) 318 to convert an output of envelope detector 320 into a digital signal to be provided to digital domain 302. Digital domain 302 and/or analog domain 304 may include a maximum detector 322 to detect a maximal power value of the envelope of signal 306; and an average detector 324 to detect an average power value of the envelope of signal 306. PAPR monitor 309 may determine the PAPR of signal 306, for example, by determining a ratio between the maximal power value of the envelope of signal 306 and the average power value of the envelope of signal 306.

In some demonstrative embodiments, PAPR monitor 309 may determine the PAPR of signal 312 and compare the PAPR of signal 306 to the PAPR of signal 312.

In some demonstrative embodiments, a PAPR of signal 306, which is lesser than a PAPR of signal 312, may indicate one or more elements of analog domain 304, e.g., chain 319 and/or PA 308, have distorted signal 306.

In some demonstrative embodiments, transmitter 300 and/or PAPR monitor 309 may increase the PAPR of signal 306, e.g., if the PAPR of signal 306 is below the PAPR of the digital signal 312.

In some demonstrative embodiments, transmitter 300 and/or PAPR monitor 309 may increase the PAPR of signal 306, for example, by reducing a power amplification of RF chain 309 and/or PA 308, e.g., until the PAPR of signal 306 is equal to the PAPR of signal 312. For example, RF chain 319 may include one or more suitable programmable gain amplifiers, and PAPR monitor 309 may utilize any control method to controllable adjust the gain of the programmable gain amplifiers. Additionally or alternatively, PAPR monitor 309 may adjust the gain of signal 305 within digital domain 302 and, as a result, the power of signal 306 may be reduced and the PAPR of signal 306 may be increased. Accordingly, proper EVM and/or spectral mask compliance of transmitter 300 may be guarantied, e.g., without increasing the power consumption of transmitter 300.

Additionally or alternatively, transmitter 300 and/or PAPR monitor 309 may increase the PAPR of signal 306, for example, by increasing the saturation power Pₛₐₜ of PA 308, for example, until the PAPR of signal 306 is equal to the PAPR of signal 312, e.g., if the PAPR of signal 306 is below the PAPR of the digital signal 312. The saturation power Pₛₐₜ of PA 308 may be increased, for example, by modifying the supply voltage VCC of PA 308. For example, transmitter 300 may include a suitable VCC adjuster 349, e.g., a controllable DC-to-DC (DC2DC) unit, capable of adjusting the VCC supply to PA 308. The saturation power Pₛₐₜ of PA 308 may be increased, for example, by increasing the supply voltage VCC, e.g., since the saturation power Pₛₐₜ may be proportional to the square, VCC², of the supply voltage. As a result, the PAPR may be increased, since the power Pₒᵤₜ may be maintained, e.g., if the PA gain is unchanged, while the saturation power Pₛₐₜ is increased. The gain may be adjusted, for example, as described above. Accordingly, proper EVM and/or spectral mask compliance of transmitter 300 may be guarantied, e.g., without lowering the transmitted power of signal 306.

In some demonstrative embodiments, a PAPR of signal 306, which is equal to the PAPR of signal 312, may indicate that, although proper EVM and/or spectral mask compliance of transmitter 300 may be guarantied, the transmission of signal 306 may not be optimal.

In some demonstrative embodiments, if the PAPR of signal 306 is equal to the PAPR of the digital signal 312, then transmitter 300 and/or PAPR monitor 309 may increase the power amplification of PA 308, for example, until detecting a decrease in the PAPR of signal 306 below the PAPR of signal 312, e.g., to a predetermined PAPR level. Accordingly, proper EVM and/or spectral mask compliance of transmitter 300 may be guarantied, e.g., while transmitting at the maximum output power from transmitter 300.

Additionally or alternatively, transmitter 300 and/or PAPR monitor 309 may decrease the saturation power Pₛₐₜ of PA 308, for example, until detecting a decrease in the PAPR of signal 306 below the PAPR of signal 312, e.g., to the predetermined PAPR level. The saturation power Pₛₐₜ of PA 308 may be decreased, for example, by modifying the supply voltage VCC of PA 308, e.g., as described above. Accordingly, proper EVM and/or spectral mask compliance of transmitter 300 may be guarantied, e.g., while consuming a minimal power, while not decreasing the transmitted power.

Referring back to FIG. 1, in some demonstrative embodiments transmitter 106 may maintain the transmission power, denoted P_{TX} of power amplifier 134, which may correspond to the transmission power of signal 126, substantially unaffected by variations in at least one of the temperature of transmitter 106 and the supply voltage VCC of power amplifier 134.

In some demonstrative embodiments, transmitter 106 may maintain the variation of the transmission power P_{TX} within a predefined variation range in response to variation of at least one of the temperature of transmitter 106 and the supply voltage VCC.

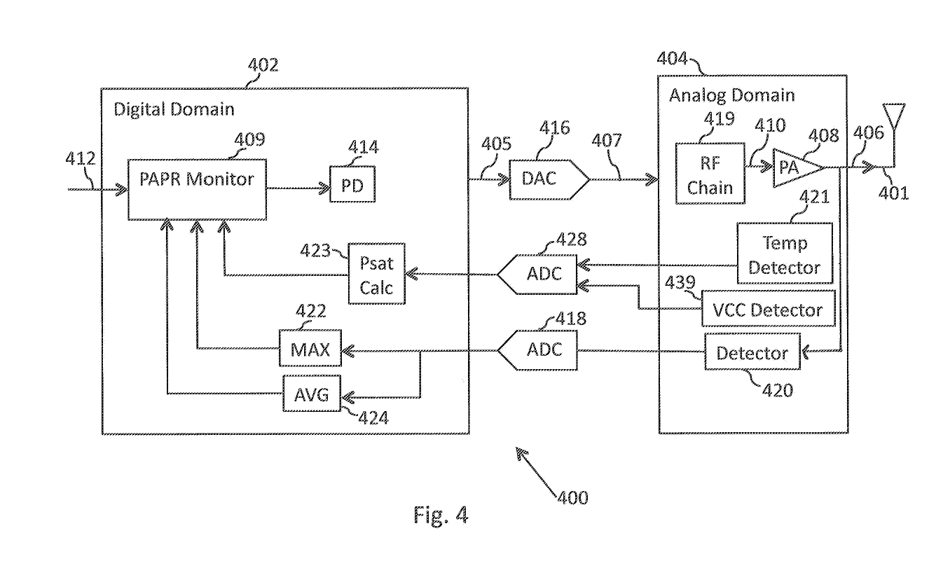

In some demonstrative embodiments, transmitter 106 may maintain the variation of the transmission power P_{TX} within the predefined variation range in response to variation of both the temperature and the supply voltage of transmitter 106, e.g., as described below with reference to FIG. 4.

In some demonstrative embodiments, the variation range may include a range of no more than 1 dBm, for example, a range of no more than 0.5 dBm, e.g., as described below.

In some demonstrative embodiments, transmitter 106 may evaluate the transmission power P_{TX} based on a pre-measured or calibrated saturation power Pₛₐₜ of power amplifier 134, e.g., as described below with reference to FIG. 4.

In some demonstrative embodiments, transmitter 106 may evaluate the transmission power P_{TX} based on a PAPR (“the saturation PAPR”) of wireless communication signal 126, when applying to power amplifier 134 a “saturation” gain at which a peak of the power of signal 126 reaches the saturation power Pₛₐₜ, e.g., as described below with reference to FIG. 4.

In some demonstrative embodiments, transmitter 106 may evaluate the transmission power P_{TX} based on a gain difference between a gain applied to power amplifier 134 and the saturation gain, e.g., as described below with reference to FIG. 4.

In some demonstrative embodiments, transmitter 106 may evaluate the saturation power Pₛₐₜ of PA 134 based on at least one of the temperature of transmitter 106 and the supply voltage VCC, e.g., as described below with reference to FIG. 4. The saturation power Pₛₐₜ and/the or a relationship, between saturation power Pₛₐₜ and the temperature of transmitter 106 and/or the supply voltage VCC, may be predetermined, for example, as part of a calibration process of transmitter 106 and/or PA 134, e.g., as described below. The relationship between the saturation power Pₛₐₜ and the temperature may be, for example, statistically determined based on several samples of a product line. The relationship between the saturation power Pₛₐₜ and the supply voltage VCC may be determined, for example, theoretically, based on a measurement of the saturation power Pₛₐₜ at a reference supply power, e.g., since the saturation power Pₛₐₜ may be proportional to VCC².

Reference is now made to FIG. 4, which schematically illustrates a transmitter 400, in accordance with another demonstrative embodiment. Transmitter 400 may perform, for example, the functionality of transmitter 106 (FIG. 1).

In some demonstrative embodiments, transmitter 400 may include a digital domain 402 to process a digital wireless communication signal 412; at least one digital-to-analog-converter (DAC) 416 to convert at least one digital output 405 of digital domain 402 into at least one analog input 407 to be provided to an analog domain 404. Analog domain 404 may include a suitable transmitter chain 419, to generate an analog wireless communication signal 410 based on analog input 407; and at least one power amplifier 408 to amplify analog wireless communication signal 410 to provide an amplified wireless communications signal 406 to be transmitted via at least one antenna 401.

In some demonstrative embodiments, the saturation power Pₛₐₜ of PA 408 may depend on the supply voltage VCC of PA 408. For example, the saturation power Pₛₐₜ of PA 408 may be approximately correlated with the square of the supply voltage VCC.

In some demonstrative embodiments, one or more first reference values of the saturation power Pₛₐₜ of PA 408 may be determined, for example, at one or more respective reference supply voltages VCC, e.g., during production testing of transmitter 400. Any suitable approximation operations, e.g., extrapolation and/or interpolation, may be performed in order to evaluate the saturation power Pₛₐₜ at a certain supply voltage based on the first reference saturation power values.

In some demonstrative embodiments, a second reference saturation power of PA 408 may be determined, for example, at a reference temperature, e.g., during production testing of transmitter 400. The saturation power of PA 408 may be assumed to have a linear dependency on the temperature of transmitter 400, e.g., as described below.

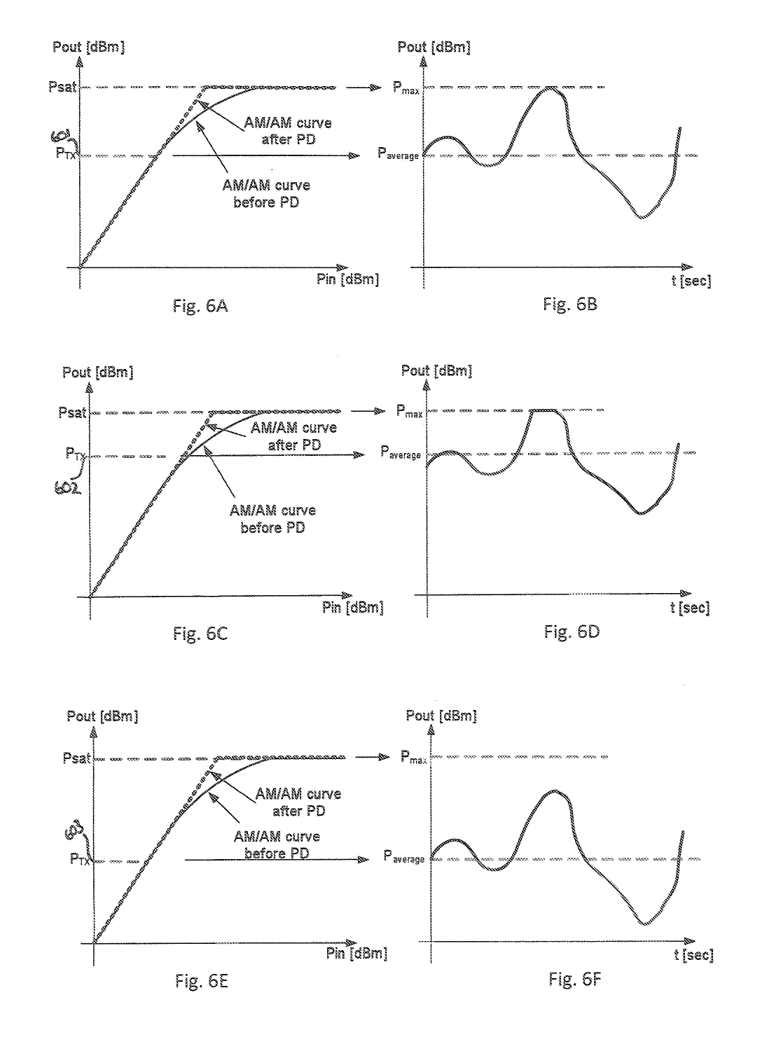

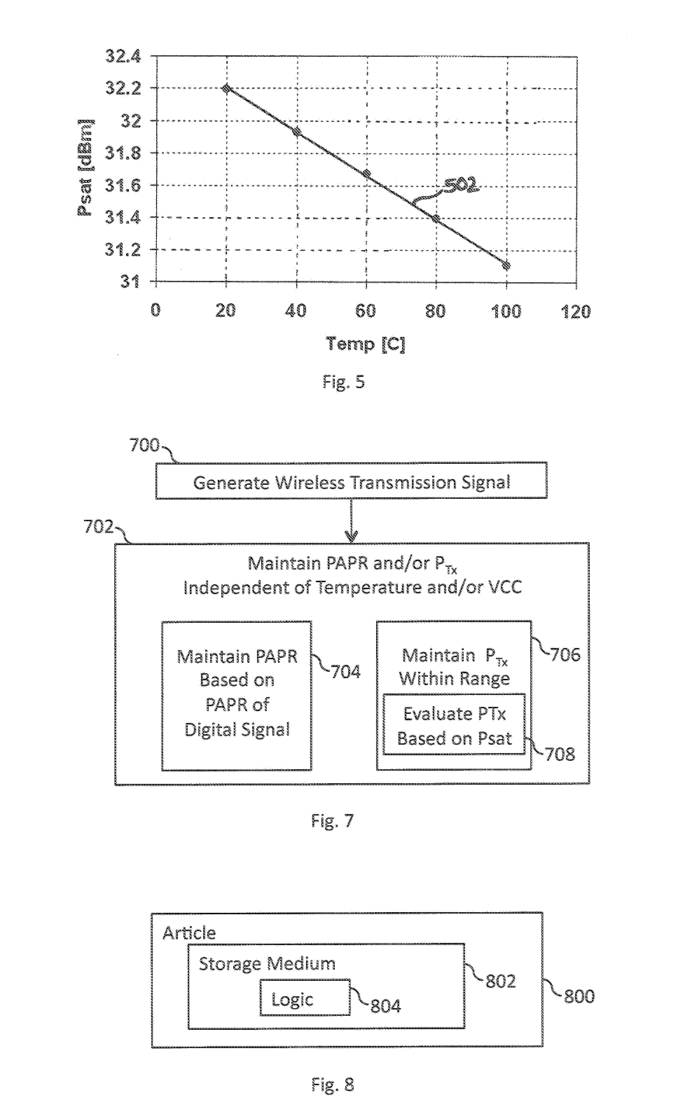

FIG. 5 schematically illustrates a graph depicting statistical average measured values of the saturation power Pₛₐₜ of a transmitter versus the temperature of the transmitter, in accordance with some demonstrative embodiments.

As shown in FIG. 5, the saturation power Pₛₐₜ may vary within a relatively narrow range in response to variation of the temperature between 20° C.-100° C. As is also shown in FIG. 5, the relationship between the saturation power Pₛₐₜ and the temperature may be approximated by a linear curve 502 having a defined slope, e.g., a slope of approximately 0.014 dB/deg. Accordingly, the saturation power Pₛₐₜ may be evaluated for a certain temperature using curve 502.

Referring back to FIG. 4, in some demonstrative embodiments, transmitter 400 may maintain a variation of the transmission power P_{TX} within a predefined variation range in response to variation of at least one of the temperature and the supply voltage of transmitter 400. The variation range may include, for example, a range of no more than 1 dBm, e.g., a range of no more than 0.5 dBm, or any other range.

In some demonstrative embodiments, transmitter 400 may evaluate the transmission power P_{TX} based on the saturation power Pₛₐₜ, e.g., as described below.

In some demonstrative embodiments, digital domain 402 may include a PAPR monitor 409 capable of monitoring the PAPR of wireless communication signal 406 and the PAPR of digital signal 412, e.g., as described in detail below.

In some demonstrative embodiments, PAPR monitor 409 may determine the PAPR, denoted PAPR_{DIG}, of digital signal 412. Digital domain 402 may apply to signal 412 any suitable processing, e.g., gain control, clipping, shaping, filtering and the like, to achieve a suitable PAPR, e.g., a minimal PAPR complying with a required EVM and/or spectral mask. For example, digital domain 402 may process signal 412 to achieve a PAPR of 6 dB, e.g., in accordance with the 802.16 standards, e.g., as described above with reference to FIG. 2. Digital domain 402 and/or analog domain 404 may also include any suitable pre-distortion module 414, for example, in order to ensure that PA 408 acts as a substantially “ideal clipping” PA.

In some demonstrative embodiments, transmitter 400 may be capable of determining the PAPR, denoted PAPR_{PA}, of signal 406. For example, transmitter 400 may include a suitable PAPR detection mechanism. In one example, transmitter 400 may include a suitable envelope detector 420, which may be implemented as part of analog domain 404, to detect a power envelope of signal 406. Transmitter 400 may also include a suitable ADC 418 to convert an output of envelope detector 420 into a digital signal to be provided to digital domain 402. Digital domain 402 and/or analog domain 404 may include a maximum detector 422 to detect a maximal power value of the envelope of signal 406; and an average detector 424 to detect an average power value of the envelope of signal 406. PAPR monitor 409 may determine the PAPR of signal 406, for example, by determining a ratio between the maximal power value of the envelope of signal 406 and the average power value of the envelope of signal 406.

In some demonstrative embodiments, transmitter 400 may determine the saturation power Pₛₐₜ of PA 408 based on the temperature and/or supply voltage of transmitter 400, for example, using the relationships between the saturation power Pₛₐₜ, the temperature and the supply voltage, e.g., as described above. For example, PAPR monitor 409 may evaluate the saturation power Pₛₐₜ based on the first reference saturation power values and the supply voltage VCC; and/or based on the second reference value and the temperature of transmitter 400. Transmitter 400 may include, for example, a temperature detector 421 to detect the temperature of transmitter 400; a supply voltage detector 439; and an evaluator 423 to evaluate the saturation power Pₛₐₜ corresponding to the detected power supply and/or the detected temperature, e.g., according to curve 502 (FIG. 5).

In some demonstrative embodiments, transmitter 400 may evaluate the transmission power P_{TX} of power amplifier 408 based on a saturation peak-to-average-power-ratio, denoted PAPRₛₐₜ, of wireless communication signal 406. The saturation peak-to-average-power-ratio PAPRₛₐₜ may include a PAPR of wireless communication signal 406, when applying to power amplifier 408 a saturation gain, denoted Gₛₐₜ, which is the minimal gain at which a peak of the power of wireless communication signal 406 reaches the saturation power Pₛₐₜ, e.g., as described below.

In some demonstrative embodiments, transmitter 400 may control the transmission power P_{TX} by controlling the gain, denoted G, applied to PA 408. For example, transmitter 400 may use any suitable DAC or analog base-band mechanism, e.g., as described above, to modify the gain G, for example, until the peaks of signal 406, e.g., as detected by envelope detector 420, reach the saturation power Pₛₐₜ.

In some demonstrative embodiments, it may be assumed that the average power of wireless communication signal 406 may change linearly, or substantially linearly, with a change in the gain G applied to PA 408. For example, it may be assumed that the average transmitted power of transmitter 400 may be located within a linear region of the AM-AM curve of PA 408, e.g., independent of whether or not pre-distortion (PD) is implemented. This assumption may be valid, for example, as long as a non-ideality of the PD is lesser than the ratio PAPR_{DIG}. Accordingly, a reduction in the ratio PAPR_{PA} may be assumed to be substantially equal to a reduction in the gain G, for example, when the peaks of signal 406, e.g., as detected by envelope detector 420, reach the saturation power Pₛₐₜ. It is noted, that, modifying the gain G may result in a variation of the ratio PAPR_{PA}, e.g., such that the ratio PAPR_{PA} may differ from the ratio PAPR_{DIG}, e.g., even before the peaks of signal 406 reach the saturation power Pₛₐₜ. For example, if a first ratio PAPR_{PA1} is determined by PAPR monitor 409, and the gain G is increased by 0.5 dBm, then a second ratio PAPR_{PA2} may be 0.5 dBm lesser than the first ratio PAPR_{PA1}, e.g., when the peaks of signal 406 reach the saturation power Pₛₐₜ.

In some demonstrative embodiments, PAPR monitor 409 may evaluate the transmission power P_{TX} of PA 408, for example, based on the saturation power Pₛₐₜ, the ratio PAPRₛₐₜ, the gain G applied to PA 408 and/or the saturation gain Gₛₐₜ. For example, PAPR monitor 409 may evaluate the transmission power P_{TX} of wireless communication signal 406, as follows:

P_{TX}=Pₛₐₜ−PAPRₛₐₜ+ΔG (1)

wherein ΔG denotes a gain difference between the gain G and the saturation gain Gₛₐₜ. The gain difference ΔG may be negative, for example, if for the required transmission power P_{TX} the momentarily signal power does not reach the saturation power Pₛₐₜ, thus P_{TX} may be lesser than P_{SAT}−PAPR. If the required transmission power P_{TX} is high enough such that the gain G is greater than the gain G_{SAT} then P_{TX}=P_{SAT}−PAPR_{PA}. In this case, the ratio PAPR_{PA} may be measured, e.g., without G detection. For example, when the ratio PAPR_{PA} is lesser than the ratio PAPR_{DIG}, then the power P_{TX} may be evaluated directly by P_{TX}=P_{SAT}−PAPR_{PA}.

In some demonstrative embodiments, transmitter 400 may determine the transmission power P_{TX} according to Equation 1, e.g., with a relatively high degree of accuracy. For example, transmitter 400 may determine the saturation power Pₛₐₜ with a relatively high degree of accuracy, for example, based on the supply voltage VCC detected by detector 439 and/or the temperature detected by detector 421, e.g., as described above. Accordingly, the accuracy of the transmission power P_{TX} may depend on an accuracy of temperature detector 421. For example, transmitter 400 may evaluate the transmission power P_{TX} with the accuracy of approximately +/−0.1 dBm, or less, e.g., if temperature detector 421 has an accuracy of about 10 degrees.

In one example, transmitter 400 may be calibrated at a single temperature point, e.g., room temperature and/or a single supply voltage, and the saturation power Pₛₐₜ may be adjusted in based on VCC² and/or in response to temperature variation using a predefined dependence function, e.g., using curve 502 (FIG. 5). According to this example, the calibration of transmitter 400 may be relatively quick, simple and/or cheap.

In some demonstrative embodiments, the ability of transmitter 400 to evaluate the transmission power P_{TX} with a relatively high degree of accuracy, may enable transmitter 400 to maintain a predefined value of the transmission power P_{TX}, e.g., in compliance with suitable mask compliance requirements. For example, upon detecting a variation in the value of the transmission power P_{TX}, transmitter 400 may controllably adjust the transmission power P_{TX} back to the predefined value.

Reference is made to FIGS. 6A, 6C and 6E, which schematically illustrate three different respective values of the average transmission power P_{TX} with respect to a AM-AM curve; and to FIGS. 6B, 6D and 6F, which schematically illustrate three curves representing momentarily output power values versus time corresponding to the three values of the transmission power P_{TX}, respectively, in accordance with some demonstrative embodiments.

As shown in FIGS. 6A and 6B, at a P_{TX} value 601 the ratio PAPR_{PA} is equal to the ratios PAPR_{DIG} and PAPRₛₐₜ. Accordingly, the transmission power P_{TX} is equal to the difference Pₛₐₜ−PAPRₛₐₜ.

As shown in FIGS. 6C and 6D, at a P_{TX} value 602, greater than P_{TX} value 601, the ratio PAPR_{PA} is lesser than the ratio PAPRₛₐₜ. Accordingly, the transmission power P_{TX} is equal to the difference Pₛₐₜ−PAPR_{PA}.

As shown in FIGS. 6E and 6F, at a P_{TX} value 603, lesser than P_{TX} value 601, the ratio PAPR_{PA} is equal to the ratio PAPR_{DIG}. Accordingly, the transmission power P_{TX} is equal to the difference Pₛₐₜ−PAPRₛₐₜ−4 G, e.g., in accordance with Equation 1.

Reference is made to FIG. 7, which schematically illustrates a method of transmitter output power management, in accordance with some demonstrative embodiments. In some embodiments, one or more operations of the method of FIG. 7 may be performed by one or more elements of a system, e.g., system 100 (FIG. 1), for example, a transmitter, e.g., transmitter 106 (FIG. 1), transmitter 300 (FIG. 3) and/or transmitter 400 (FIG. 4).

As indicated at block 700, the method may include generating a wireless communication signal to be transmitted by a transmitter. For example, transmitter 106 (FIG. 1) may generate wireless communication signal 126 (FIG. 1), e.g., as described above.

As indicated at block 702, the method may include monitoring, adjusting and/or maintaining at least one of a PAPR of the wireless communication signal and the transmission power P_{TX} substantially unaffected by variations in at least one of a temperature of the transmitter and a supply voltage of the transmitter. For example, transmitter 106 (FIG. 1) may maintain at least one of a PAPR of wireless communication signal 126 (FIG. 1) and the transmission power P_{TX} substantially independent of at least one of a temperature and a supply voltage of transmitter 106 (FIG. 1), e.g., as described above.

As indicated at block 704, maintaining the PAPR and/or the transmission power P_{TX} may include maintaining the PAPR of the wireless communication signal based on a PAPR of a corresponding digital signal. For example transmitter 106 (FIG. 1) may maintain the PAPR of wireless communication signal 126 (FIG. 1) based on the PAPR of digital signal 130 (FIG. 1), e.g., as described above.

As indicated at block 706, maintaining the PAPR and/or the transmission power P_{TX} may include maintaining a variation of the transmission power P_{TX} of the transmitter within a predefined variation range in response to variation of the temperature and/or supply voltage of the transmitter. For example, transmitter 106 (FIG. 1) may maintain a variation of the transmission power P_{TX} of PA 134 (FIG. 1) within a predefined variation range in response to variation of the temperature and/or supply voltage of transmitter 106 (FIG. 1), e.g., as described above.

As indicated at block 708, maintaining the variation of the transmission power P_{TX} may include evaluating the transmission power P_{TX} based on a saturation power of the power amplifier. For example, transmitter 400 (FIG. 4) may evaluate the transmission power P_{TX} based on the saturation power Pₛₐₜ of PA 408 (FIG. 1), for example, according to Equation 1, e.g., as described above.

Reference is made to FIG. 8, which schematically illustrates an article of manufacture 800, in accordance with some demonstrative embodiments. Article 800 may include a machine-readable storage medium 802 to store logic 804, which may be used, for example, to perform at least part of the functionality of transmitter 106 (FIG. 1) and/or to perform one or more operations of the method of FIG. 7.

In some demonstrative embodiments, article 800 and/or machine-readable storage medium 802 may include one or more types of computer-readable storage media capable of storing data, including volatile memory, non-volatile memory, removable or non-removable memory, erasable or non-erasable memory, writeable or re-writeable memory, and the like. For example, machine-readable storage medium 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus including:
a transmitter to generate a wireless communication signal,
wherein the transmitter is to monitor a peak-to-average-power-ratio (PAPR) of the wireless communication signal and to adjust the PAPR of the wireless communication signal based on a reference PAPR.

2. The apparatus of claim 1, wherein the transmitter is to adjust the PAPR of the wireless communication signal, such that the PAPR of the wireless communication signal is substantially unaffected by variations in at least one of a temperature of the transmitter and a supply voltage of the transmitter.

3. The apparatus of claim 1, wherein the wireless communication signal includes an analog signal, wherein the transmitter is to generate the analog signal based on a digital signal, and wherein the transmitter is to adjust the PAPR of the wireless communication signal based on a PAPR of the digital signal.

4. The apparatus of claim 3, wherein, if the PAPR of the wireless communication is below the PAPR of the digital signal, the transmitter is to increase the PAPR of the wireless communication signal by performing at least one of reducing a power amplification and increasing a saturation power of the transmitter.

5. The apparatus of claim 3, wherein, if the PAPR of the digital signal is equal to the PAPR of the wireless communication signal, the transmitter is to perform at least one of increasing a power amplification and decreasing a saturation power of the transmitter

6. The apparatus of claim 1, wherein the wireless communication signal includes an analog signal, wherein the transmitter is to generate the analog signal based on a digital signal,
wherein the transmitter includes a first PAPR detector to detect the PAPR of the digital signal and a second PAPR detector to detect a second PAPR of the analog signal,
wherein the transmitter is to adjust the PAPR of the analog signal such that a power level of the analog signal is substantially equal to a maximal power level allowed by at least one of a predefined transmission mask and a predefined quality factor.

7. An system including:
at least one antenna; and
a transmitter including a power amplifier to generate a wireless communication signal to be transmitted via the antenna,
wherein the transmitter is to maintain a variation of a transmission power of the power amplifier within a predefined variation range in response to variation of at least one of a temperature of the transmitter and a supply voltage of the power amplifier.

8. The system of claim 7, wherein the transmitter is to evaluate the transmission power of the power amplifier based on a saturation power of the power amplifier.

9. The system of claim 8, wherein the transmitter is to evaluate the transmission power of the power amplifier based on a saturation peak-to-average-power-ratio of the wireless communication signal.

10. The system of claim 9, wherein the saturation peak-to-average-power-ratio includes peak-to-average-power-ratio of the wireless communication signal when applying to the power amplifier a saturation gain at which a peak of the power of the wireless communication signal reaches the saturation power.

11. The system of claim 10, wherein the transmitter is to evaluate the transmission power of the power amplifier based on a gain difference between a gain applied to the power amplifier and the saturation gain.

12. The system of claim 8, wherein the transmitter is to evaluate the saturation power based on at least one of the temperature of the transmitter and the supply voltage of the power amplifier.

13. The system of claim 7, wherein the variation range includes a range of no more than 1 decibel (dB).

14. The system of claim 13, wherein the variation range includes a range of no more than 0.5 dB

15. The system of claim 7, wherein the transmitter includes:
a first peak-to-average-power-ratio (PAPR) detector to detect a first PAPR of the wireless communication signal in a digital domain; and
a second PAPR detector to detect a second PAPR of the wireless communication signal in an analog domain,
wherein the transmitter is to adjust the transmission power based on the first PAPR, the second PAPR and a saturation power of the power amplifier, such that the transmission power is maintained within a range corresponding to predefined minimal and maximal transmission powers.

16. A method including:
generating a wireless communication signal to be transmitted by a transmitter; and
controllably maintaining at least one of a peak-to-average-power-ratio (PAPR) of the wireless communication signal and a transmission power of the transmitter substantially unaffected by variations in at least one of a temperature of the transmitter and a supply voltage of the transmitter.

17. The method of claim 16, wherein generating the wireless communication signal includes generating an analog wireless communication signal based on a digital signal, and wherein maintaining the PAPR of the wireless communication signal includes maintaining the PAPR of the analog wireless communication signal based on a PAPR of the digital signal.

18. The method of claim 16 including evaluating the transmission power based on a saturation power of the transmitter.

19. The method of claim 18, wherein evaluating the transmission power includes evaluating the transmission power based on a saturation peak-to-average-power-ratio of the wireless communication signal.

20. The method of claim 18 including evaluating the saturation power based on at least one of the temperature and a supply voltage of the transmitter.
